(19) United States
(12) Patent Application Publication
(10) Pub. No.: US 2024/0288874 A1
(43) Pub. Date: Aug. 29, 2024

(54) REMOTE CONTROL SYSTEM, METHOD, AND PROGRAM

(71) Applicant: NIPPON TELEGRAPH AND TELEPHONE CORPORATION, Tokyo (JP)

(72) Inventors: Masato FUKUDA, Musashino-shi, Tokyo (JP); Daisuke SATO, Musashino-shi, Tokyo (JP); Masato MIYAHARA, Musashino-shi, Tokyo (JP); Narimune MATSUMURA, Musashino-shi, Tokyo (JP); Yoshiki NISHIKAWA, Musashino-shi, Tokyo (JP)

(73) Assignee: NIPPON TELEGRAPH AND TELEPHONE CORPORATION, Tokyo (JP)

(21) Appl. No.: 18/573,453

(22) PCT Filed: Jun. 28, 2021
(86) PCT No.: PCT/JP2021/024388

§ 371 Date: Dec. 22, 2023

(51) Int. Cl. G05D 1/222; G05D 111/30; H04L 43/0852

(52) U.S. Cl. CPC G05D 1/222; H04L 43/0852; G05D 2111/32

(57) ABSTRACT

A remote control system that remotely controls an operation of a control target. The system includes a remote control device; and a prediction processing device. The remote control device includes a transmitter that transmits a control signal for controlling an operation of a remote control target to the control target, and the prediction processing device includes a delay time prediction processing unit that predicts a delay time from transmission of the control signal from the remote control device to feedback to control of the operation of the remote control target. The prediction processing device further includes a generation unit that generates a control signal for controlling an operation for the remote control device.

### TECHNICAL FIELD

An embodiment of the present invention relates to a remote control system, a method, and a program.

### BACKGROUND ART

With the spread of the Internet and the like and increase in communication speed in recent years, efforts have been made to construct a remote control system for remotely controlling a control target device, such as an automatic guided vehicle (AGV) located at a remote location, a pilotless plane such as a drone, construction equipment, a security robot, a disaster rescue robot, and a remote surgery support robot, from a remote control device via a communication network.

In a remote control system, generally, a camera mounted on a control target device is used to capture a video of the control target device and surroundings thereof.

Further, the captured video is transmitted from the control target device to the remote control device, operated by a human who is an operator while the video is projected on the remote control device to be monitored, and a control signal associated with the operation is transmitted from the remote control device to the control target device, whereby the control target device is remotely operated.

Under an environment in which a communication delay occurs in a communication network in a remote control system that remotely controls a remote control target (which may be simply referred to as a controlled target) such as a robot by a remote control device as described above, since work efficiency of the remote control system decreases, a remote control technique utilizing a prediction result of a control signal at timing in which the delay is reflected is utilized.

For example, Non Patent Literature 1 discloses remote control based on a fluctuation prediction result of a communication delay amount. In this control, the communication delay amount is predicted, and the control target at a remote location is controlled by applying a threshold value at which the remote control does not overshoot when the communication delay amount is reflected, whereby stability of the control is ensured.

### CITATION LIST

### Non Patent Literature

Non Patent Literature 1: Dynamic state-predictive control for a remote control system with large delay fluctuation, Hiroshi Yoshida; Taichi Kumagai; Kozo Satoda, IEEE, 2018

### SUMMARY OF INVENTION

### Technical Problem

In a remote control system in which a remote control target such as a robot is remotely controlled by a remote control device, in addition to the communication delay described above and detection of an input to a controller, processing delays due to processing of various devices such as processing by a server, processing related to actuation of a robot, and rendering processing of a head mounted display (HMD) in a virtual reality (VR) environment are accumulated.

Since the accumulated delay causes a time lag between a control input by a human and a feedback of an operation result with respect to the control input, work efficiency of the human is reduced.

In the control disclosed in Non Patent Literature 1, stability of the control is ensured by remote control based on a prediction of fluctuation of the communication delay amount. However, in a case where a human performs the control input related to the remote control, the time lag between the control input by the human and the feedback of the operation result with respect to the control input has not been resolved. As a result, work efficiency of a human is reduced, and stability of the control is not ensured.

Furthermore, the content disclosed in Non Patent Literature 1 is intended for communication delay. On the other hand, the delay amount that affects human operability is not limited to the communication delay, and includes a processing delay that is the time related to the rendering processing of the HMD in addition to the time related to the actuation of the robot.

Therefore, in the remote control, in the remote control at a timing in which only the communication delay is reflected, the reduction in work efficiency of a person is not prevented, and stability of the control is not sufficiently ensured.

The present invention has been made in view of the above circumstances, and an object thereof is to provide a remote control system, a method, and a program capable of performing remote control that is not affected by a delay with a remote control target.

### Solution to Problem

A remote control system according to an aspect of the present invention remotely controls an operation of a control target, the system including: a remote control device; and a prediction processing device, in which the remote control device includes a transmission unit that transmits a control signal for controlling an operation of a remote control target to the control target, and the prediction processing device includes a delay time prediction processing unit that predicts a delay time from transmission of the control signal from the remote control device to feedback to control of the operation of the remote control target, on the basis of the control signal transmitted from the remote control device, and a generation unit that generates a control signal for controlling an operation for the remote control device at a timing in which the delay time is reflected in a transmission timing of the control signal from the remote control device, on the basis of the delay time predicted by the delay time prediction processing unit and the control signal transmitted from the remote control device.

A remote control method according to another aspect of the present invention, which is performed by a remote control system that includes a remote control device and a prediction processing device and remotely controls an operation of a control target, includes: transmitting a control signal for controlling an operation of a remote control target to the control target by the remote control device; predicting a delay time from transmission of the control signal from the remote control device to feedback to control of the operation of the remote control target by a delay time prediction processing unit, on the basis of the control signal transmitted from the remote control device; and generating a control signal for controlling an operation for the remote control device at a timing in which the delay time is reflected in a transmission timing of the control signal from the remote control device, on the basis of the delay time predicted by the prediction processing device and the control signal transmitted from the remote control device.

### Advantageous Effects of Invention

According to the present invention, it is possible to perform remote control that is not affected by a delay with a remote control target.

### BRIEF DESCRIPTION OF DRAWINGS

FIG. 1 is a diagram illustrating an example of an outline of general delay prediction control.

FIG. 2 is a diagram illustrating an example of an outline of delay prediction control according to an embodiment of the present invention.

FIG. 3 is a block diagram illustrating an application example of a remote control system according to an embodiment of the present invention.

FIG. 4 is a flowchart illustrating an example of a processing procedure of a remote control device of a remote control system according to an embodiment of the present invention.

FIG. 5 is a flowchart illustrating an example of a processing procedure of a control target device of a remote control system according to an embodiment of the present invention.

FIG. 6 is a block diagram illustrating an example of a hardware configuration of a remote control device of a remote control system according to an embodiment of the present invention.

### DESCRIPTION OF EMBODIMENTS

Hereinafter, an embodiment according to the present invention will be described with reference to the drawings.

In an embodiment of the present invention, an end-to-end (E2E) delay time from a control input by a human who is an operator to a remote control device of a remote control system to feedback to control of a remote control target is predicted.

In the present embodiment, in addition to the prediction, a future control signal is predicted in consideration of a value of an allowable delay amount that is a time in which a human does not feel a delay. Further, by operating a robot on the basis of the predicted control signal, remote control without delay is implemented. The allowable delay amount is a threshold value at which both a decrease in operability by an operator and an increase in work time of the operator are not observed.

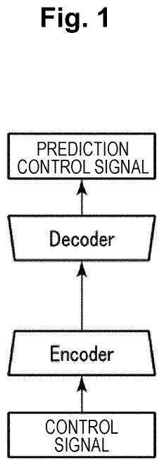

FIG. 1 is a diagram illustrating an example of an outline of general delay prediction control.

In general delay prediction control, a mathematical model in which a delayed control signal is converted into a prediction control signal that is a future control signal is used.

FIG. 1 illustrates an example in which the mathematical model includes an encoder and a decoder. The mathematical model is not limited to the configuration illustrated in FIG. 1, and may be, for example, a model calculated from known parameters of a robot.

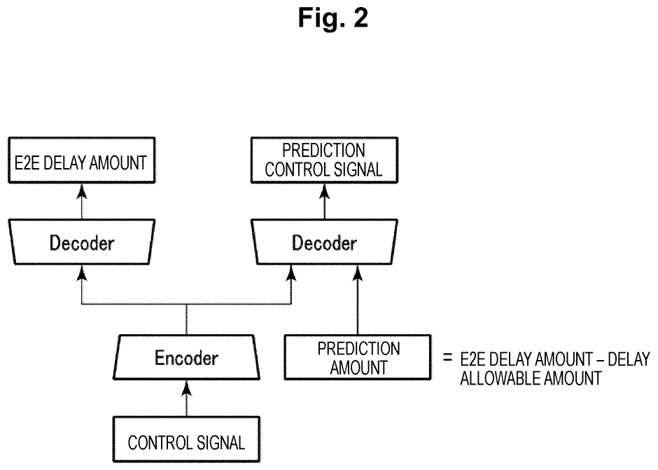

FIG. 2 is a diagram illustrating an example of an outline of delay prediction control according to an embodiment of the present invention.

As illustrated in FIG. 2, in the delay prediction control according to an embodiment of the present invention, a model in which a delayed control signal is input to an encoder, an end-to-end delay time from the control input until feedback for operation control returns to the remote control device is output from a first decoder on the basis of the control signal, and a prediction control signal is output from a second decoder on the basis of the control signal from the encoder while a delay allowable value that does not deteriorate operability of an operator is reflected may be applied.

In the model, for example, two outputs can be obtained from one encoder by multitasking learning, so that an advantageous effect that high-speed calculation is possible can be obtained.

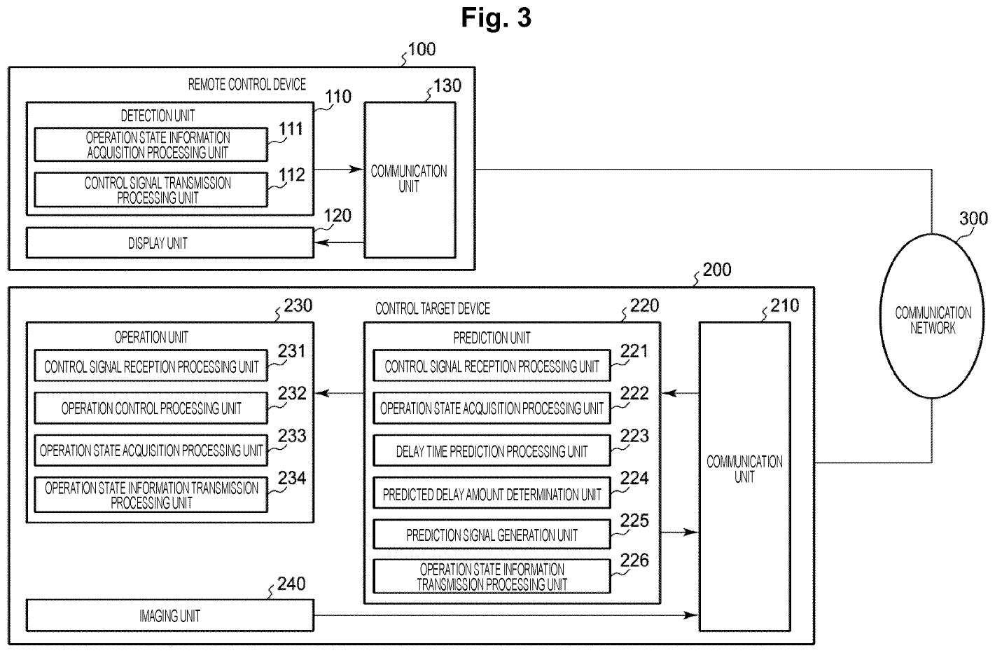

FIG. 3 is a diagram illustrating an application example of the remote control system according to an embodiment of the present invention.

In the example illustrated in FIG. 3, the remote control system according to an embodiment of the present invention includes a remote control device 100 that receives an operation related to a control input by an operator, and a control target device 200 that operates at a remote location as viewed from the remote control device 100 in response to the operation. The remote control device 100 and the control target device 200 are communicatively connected by a communication network 300. The remote control device 100 remotely controls the control target device 200 via the communication network 300.

Next, a configuration and operation of the remote control device 100 illustrated in FIG. 3 will be described. The remote control device 100 includes a detection unit 110, a display unit 120, and a communication unit 130. The detection unit 110 detects a control input by an operator.

The display unit 120 displays a result of the operation of the control target device 200 by a display device or the like.

The communication unit 130 transmits and receives information obtained by being detected by the detection unit 110, information displayed by the display unit 120, and the like to and from the control target device 200 via the communication network 300.

Next, each unit of the detection unit 110 will be described.

The detection unit 110 includes an operation state information acquisition processing unit 111 and a control signal transmission processing unit 112.

The operation state information acquisition processing unit 111 detects a control input that is operation state information of an operator, or operation state information transmitted from the control target device 200, for example, information including a position and operation speed of the control target device 200. The control input may be a body motion of a human or an operation input to a terminal such as a controller.

The control signal transmission processing unit 112 transmits a control signal of the remote control target based on the control input detected by the operation state information acquisition processing unit 111 to the control target device 200 via the communication unit 130 or the like. The control signal may include a target value related to an operation speed related to, for example, a moving direction, a moving distance, a rotation direction, a rotation angle, a position of a robot arm, and the like when the remote control target is a robot.

Next, a configuration and operation of the control target device 200 illustrated in FIG. 3 will be described. The control target device 200 is a device remotely controlled by the remote control device 100 via the communication network 300. The control target device 200 can be installed, for example, at a construction site or the like. As the control target device 200, for example, a machine such as an AGV, a drone, a construction machine, a security robot, a disaster rescue robot, or a remote surgery support robot can be used.

The control target device 200 includes a communication unit 210, a prediction unit 220, an operation unit 230, and an imaging unit 240.

The prediction unit 220 performs prediction processing on a control signal input from the remote control device 100 due to a communication delay and a processing delay. In the example illustrated in FIG. 3, an example in which the prediction unit 220 is mounted on the control target device 200 is illustrated, but the present invention is not limited thereto, and the prediction unit 220 may include, for example, a prediction processing device separated from the control target device 200.

The operation unit 230 includes a remote control target that performs a predetermined operation, and actually controls the operation of the remote control target in response to a result of the prediction processing by the prediction unit 220.

The imaging unit 240 acquires, as an image or a moving image, a result of the actual operation of the remote control target according to the control by the operation unit 230.

The communication unit 210 transmits and receives a control signal from the remote control device 100 or a video or the like acquired by the imaging unit 240 to and from the remote control device 100 via the communication network 300.

Next, each unit of the prediction unit 220 will be described.

The prediction unit 220 includes a control signal reception processing unit 221, an operation state acquisition processing unit 222, a delay time prediction processing unit 223, a predicted delay amount determination unit 224, a prediction signal generation unit 225, and an operation state information transmission processing unit 226.

The control signal reception processing unit 221 receives a control signal transmitted from the control signal transmission processing unit 112 of the remote control device 100 via the communication network 300.

The operation state acquisition processing unit 222 acquires operation state information indicating an operation state related to a current operation of the remote control target of the operation unit 230, for example, movement, rotation, turning, sliding, expansion or contraction, or the like. For example, in a case where the remote control target is a six-axis control robot arm, a rotation angle and torque information, which are operation statuses of each actuator (not illustrated), can be detected by sensors (not illustrated) and acquired by the operation state acquisition processing unit 222.

The delay time prediction processing unit 223 predicts a delay time, which is an end-to-end delay amount of the remote control system, from the control signal transmitted from the control signal transmission processing unit 112 of the remote control device 100 via the communication network 300. In the present embodiment, the delay time is predicted on the basis of the state of the body motion of the human by utilizing characteristics that the human adjusts the body motion according to the delay amount.

The prediction of the delay time that is the end-to-end delay amount may be performed by a multilayer perceptron that is a general neural network model, or may be performed by a recurrent neural network (RNN; Recursive neural network) that is a neural network model suitable for time series data.

The predicted delay amount determination unit 224 inputs the end-to-end delay amount of the remote control system predicted by the delay time prediction processing unit 223, and inputs an allowable delay amount which is a value that a human does not feel an influence of a delay and is a known numerical value given from the outside. The predicted delay amount determination unit 224 determines a predicted amount that is a delay amount to be predicted by the prediction unit 220 from the input delay amount and allowable delay amount.

The prediction signal generation unit 225 generates a future prediction control signal related to the control target device 200 on the basis of the prediction amount determined by the predicted delay amount determination unit 224 and the control signal transmitted from the control signal transmission processing unit 112 of the remote control device 100 via the communication network 300.

The operation state information transmission processing unit 226 transmits the future prediction control signal of the control target device generated by the prediction signal generation unit 225 to the operation unit 230.

Next, each unit of the operation unit 230 will be described.

The operation unit 230 includes a control signal reception processing unit 231, an operation control processing unit (which may be referred to as an operation control unit) 232, an operation state acquisition processing unit 233, and an operation state information transmission processing unit 234.

The control signal reception processing unit 231 receives the prediction control signal transmitted from the operation state information transmission processing unit 226 of the prediction unit 220.

The operation control processing unit 232 executes each control related to the operation on the remote control target according to the control signal received by the control signal reception processing unit 231.

The operation state acquisition processing unit 233 acquires operation state information indicating a state of an operation executed by the operation control processing unit 232.

The operation state information transmission processing unit 234 transmits the operation state information acquired by the operation state acquisition processing unit 233 to the remote control device 100 via the communication unit 210.

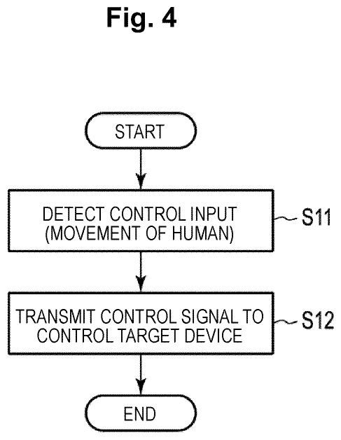

Next, a processing procedure of the remote control device 100 will be described. FIG. 4 is a flowchart illustrating an example of a processing procedure of the remote control device of the remote control system according to an embodiment of the present invention.

First, the operation state information acquisition processing unit 111 of the detection unit 110 of the remote control device 100 detects a control input of an operator, for example, movement of a human, as a control signal (S11).

Further, the control signal transmission processing unit 112 of the detection unit 110 transmits the control signal detected in S11 to the control target device 200 (S12).

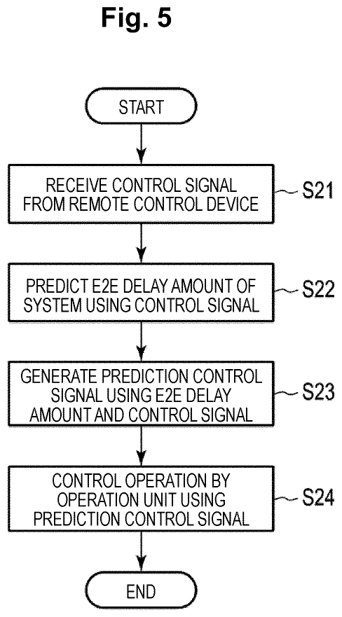

Next, a processing procedure of the control target device 200 will be described. FIG. 5 is a flowchart illustrating an example of a processing procedure of the control target device of the remote control system according to an embodiment of the present invention.

First, the control signal reception processing unit 221 of the prediction unit 220 of the control target device 200 receives the control signal transmitted from the remote control device 100 via the communication network 300 (S21).

Next, the delay time prediction processing unit 223 of the prediction unit 220 predicts the E2E delay amount of the remote control system using the control signal received in S21 (S22).

Next, the prediction signal generation unit 225 of the prediction unit 220 generates a prediction control signal using the E2E delay amount predicted in S22 and the control signal received in S21 (S23).

Next, the operation control processing unit 232 of the operation unit 230 actually controls the operation of the remote control target by using the prediction control signal generated in S23 (S24).

In the present embodiment, in any system, even in remote control via the communication network in which a communication delay and a processing delay occur, the delay can be alleviated, and the control target device can be naturally remotely controlled.

In the present embodiment, an end-to-end delay amount in a certain device configuration of a system can be measured without measuring a delay amount between devices. In the present embodiment, a prediction function capable of compensating the operability of an operator can be constructed in the prediction control of the remote control.

In the present embodiment, in addition to prediction of the E2E delay amount, a future control signal is predicted up to a value of an allowable delay amount at which a human does not feel a delay, and a remote control target such as a robot is operated on the basis of the predicted control signal, thereby realizing remote control without delay, and preventing a decrease in work efficiency due to a communication delay and a processing delay.

A remote control system according to an embodiment of the present embodiment includes a delay time prediction processing unit that utilizes a characteristic that a human adjusts a body motion according to a delay amount and estimates an E2E delay of a system from a state of the body motion of the human, and a predicted delay amount determination unit that determines a delay amount to be predicted by the system from the E2E delay amount and an allowable delay amount, and is implemented by a lightweight prediction unit that can output the E2E delay amount and a prediction control signal from the same model by multitasking learning.

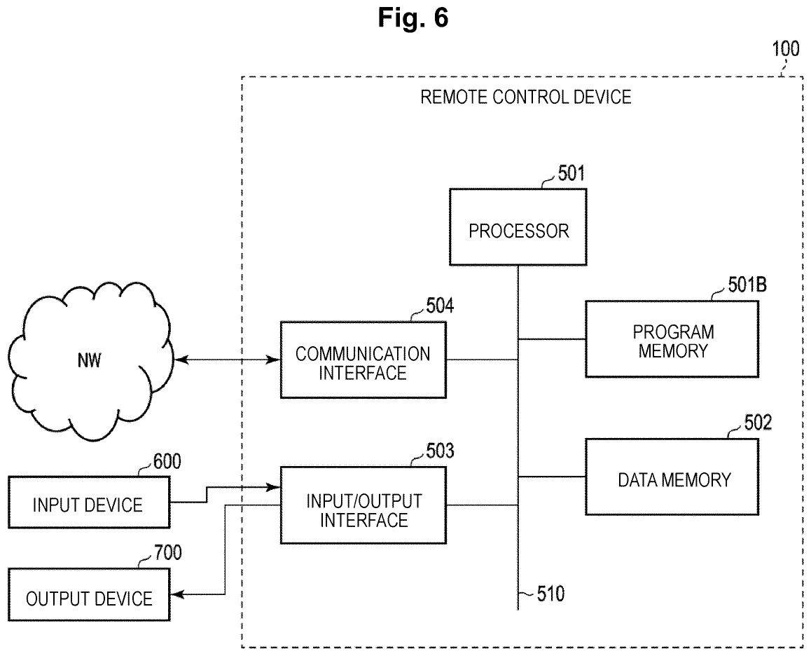

FIG. 6 is a block diagram illustrating an example of a hardware configuration of the remote control device of the remote control system according to an embodiment of the present invention.

In the example illustrated in the drawing, each unit of the detection unit 110, the display unit 120, and the communication unit 130 of the remote control device 100 illustrated in FIG. 3 is constituted by, for example, a server computer or a personal computer, and includes a hardware processor 501 such as a central processing unit (CPU). Moreover, a program memory 501B, a data memory 502, an input/output interface 503, and a communication interface 504 are connected to the hardware processor 501 via a bus 510. The same applies to each unit in the communication unit 210, the prediction unit 220, and the operation unit 230 of the control target device 200 illustrated in FIG. 3.

The communication interface 504 includes one or more wireless communication interface units, for example, and enables information transmission and reception to and from a communication network NW. As a wireless interface, for example, an interface adopting a low-power wireless data communication standard, such as a wireless local area network (LAN), can be used.

An input device 600 and an output device 700 for operators that are attached to the remote control device 100 are connected to the input/output interface 503. The input/output interface 503 performs a process of fetching operation data input by an operator through the input device 600, which is a keyboard, a touch panel, a touchpad, a mouse, or the like, and outputting output data to the output device 700 including a display device formed with liquid crystal, organic electro-luminescence (EL), or the like to display the output data. Note that, as the input device 600 and the output device 700, a device built in the remote control device 100 may be used, or an input device and an output device of another information terminal that can communicate with the remote control device 100 via the communication network NW may be used. The same applies to the communication unit 210 and the like of the control target device 200.

The program memory 501B is used as a non-transitory physical storage medium in a combination of a non-volatile memory that is writable and readable at any time, such as a hard disk drive (HDD) or a solid state drive (SSD), and a non-volatile memory such as a read only memory (ROM), for example, and stores programs necessary for performing various processes according to an embodiment.

The data memory 502 is used as a physical storage medium in a combination of the above non-volatile memory and a volatile memory such as a random access memory (RAM), for example, and can be used to store various kinds of data acquired and created in the process of performing various kinds of processing. The data memory 502 can store various data or information.

The remote control device 100 according to an embodiment of the present invention can be configured as a data processing device including the detection unit 110 and the communication unit 113 illustrated in FIG. 3 as a processing functional unit by software. Similarly, the control target device 200 according to an embodiment of the present invention can be configured as a data processing device including the communication unit 201, the prediction unit 202, and each unit in the operation unit 230 illustrated in FIG. 3 as a processing function unit by software.

Meanwhile, the information storage units to be used as work memories or the like by the respective units of the remote control device 100 and the control target device 200 can be configured by the data memory 502 illustrated in FIG. 6. However, the above various kinds of databases are not essential components in the remote control device 100 and the control target device 200, and may be provided in an external storage medium such as a universal serial bus (USB) memory, or a storage device such as a database server disposed in a cloud, for example.

Both the processing function units in the respective units of the remote control device 100 illustrated in FIG. 3 and the processing function units in the respective units of the control target device 200 illustrated in FIG. 3 can be implemented by causing the hardware processor to read and execute a program stored in the program memory 501B. Note that some or all of these processing functional units may be formed in other various modes including an integrated circuit such as an application specific integrated circuit (ASIC) or a field-programmable gate array (FPGA).

Further, the methods described in the respective embodiments can be stored as a program (software means) that can be executed by a computer into a recording medium such as a magnetic disk (a floppy (registered trademark) disk, a hard disk, or the like), an optical disc (a CD-ROM, a DVD, an MO, or the like), or a semiconductor memory (a ROM, a RAM, a flash memory, or the like), and can be transmitted and distributed through a communication medium. Note that the programs stored on the medium side also include a setting program for configuring, in the computer, a software means (including not only an execution program but also tables and data structures) to be executed by the computer. The computer that forms this device performs the above processes by reading the programs recorded in the recording medium, constructing the software means according to the setting program as needed, and controlling operations with the software means. Note that the recording medium in this specification is not necessarily a recording medium for distribution, but includes a storage medium such as a magnetic disk or a semiconductor memory provided in the computer or in a device connected via a network.

Note that the present invention is not limited to the above-described embodiments, and various modifications can be made to them at the implementation stage without departing from the scope of the invention. The respective embodiments may also be implemented in an appropriate combination that can achieve combined effects. Furthermore, the embodiments described above include various inventions, and various inventions can be extracted by a combination selected from a plurality of disclosed components. For example, even if some components are eliminated from all the components described in the embodiment, in a case where the problem can be solved and the advantageous effects can be obtained, a configuration from which the components are eliminated can be extracted as an invention.

Reference Signs List

| | |
|---|---|
| 100 | Remote control device |
| 200 | Control target device |
| 300 | Communication network |
| 110 | Detection unit |
| 120 | Display unit |
| 130, 210 | Communication unit |
| 220 | Prediction unit |
| 230 | Operation unit |
| 240 | Imaging unit |

1. A remote control system for remotely controlling an operation of a control target, the remote control system comprising:
a remote controller; and
a prediction processor,
wherein the remote controller includes
a transmitter that transmits a control signal for controlling an operation of a remote control target to the control target, and
the prediction processor includes
delay time prediction processing circuitry that predicts a delay time from transmission of the control signal from the remote controller to feedback to control of the operation of the remote control target, on the basis of the control signal transmitted from the remote controller, and
generation circuitry that generates a control signal for controlling an operation for the remote controller at a timing in which the delay time is reflected in a transmission timing of the control signal from the remote controller, on the basis of the delay time predicted by the delay time prediction processing circuitry unit and the control signal transmitted from the remote controller.

2. The remote control system according to claim 1, wherein;
the generation circuitry generates the control signal for controlling the operation on the remote controller at a timing obtained by subtracting an allowable value of the delay time from the delay time predicted by the delay time prediction processing circuitry at a transmission timing of the control signal from the remote controller, on the basis of the delay time predicted by the delay time prediction processing circuitry and the control signal transmitted from the remote controller.

3. The remote control system according to claim 1, wherein the prediction processor further includes:
operation control circuitry that controls an operation of the remote controller at a timing in which the delay time is reflected in the transmission timing, on the basis of the control signal generated by the generation circuitry.

4. A remote control method, comprising:
transmitting a control signal for controlling an operation of a remote control target to a control target;
predicting a delay time from transmission of the control signal to feedback to control the operation of the remote control target, on the basis of the control signal transmitted from a remote controller; and
generating a control signal for controlling an operation for the remote controller at a timing in which the delay time is reflected in a transmission timing of the control signal from the remote controller, on the basis of the delay time which was predicted and the control signal which was transmitted.

5. The remote control method according to claim 4, wherein the generating includes:
generating the control signal for controlling the operation on the remote controller at a timing obtained by subtracting an allowable value of the delay time from the delay time predicted at a transmission timing of the control signal from the remote controller, on the basis of the predicted delay time and the control signal transmitted from the remote controller.

6. The remote control method according to claim 4, further comprising:
controlling an operation of the remote controller at a timing in which the delay time is reflected in the transmission timing, by the prediction processor on the basis of the generated control signal.

7. A non-transitory computer readable medium storing a remote control processing program for causing a processor to function as the transmitter of the remote controller of the remote control system according to claim 1 and each unit of the prediction processor.

8. A non-transitory computer readable medium storing a remote control processing program for causing a processor to perform the method of claim 4.
